(19) United States
(12) Patent Application Publication
(10) Pub. No.: US 2025/0125853 A1
(43) Pub. Date: Apr. 17, 2025

(54) SYSTEMS AND METHODS FOR SINGLE CHANNEL STATE INFORMATION REPORT

(71) Applicant: ZTE Corporation, Shenzhen (CN)

(72) Inventors: Hong Tang, Shenzhen (CN); Xiaoying Ma, Shenzhen (CN); Jun Xu, Shenzhen (CN); Mengzhu Chen, Shenzhen (CN); Bo Dai, Shenzhen (CN); Quijin Guo, Shenzhen (CN); Xuan Ma, Shenzhen (CN)

(21) Appl. No.: 18/991,258

(22) Filed: Dec. 20, 2024

Related U.S. Application Data
(63) Continuation of application No. PCT/CN2022/140727, filed on Dec. 21, 2022.

(51) Int. Cl. H04B 7/06; H04W 76/20

(52) U.S. Cl. CPC H04B 7/0626; H04B 7/063; H04W 76/20

(57) ABSTRACT

This disclosure is directed to methods, systems, and devices related to wireless communication, and more specifically, methods, systems, and devices related single channel state information reporting. A method of wireless communication, comprising receiving, by a wireless communication device, from a network device, a radio resource control (RRC) signaling; wherein the RRC signaling includes at least a channel state information (CSI) report configuration and a CSI resource configuration; transmitting, by the wireless communication device, a complete CSI report according to the RRC signaling; and wherein the complete CSI report contains multiple CSI reports A method of wireless communication, comprising.

### TECHNICAL FIELD

This application is a continuation and claims priority to International Application No. PCT/CN2022/140727, filed on Dec. 21, 2022, the disclosure of which is hereby incorporated by reference herein in its entirety.

This disclosure is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed related to channel state information reporting that can be implemented by embodiments in mobile communication technology, including 5th Generation (5G), new radio (NR), 4th Generation (4G), and long-term evolution (LTE) communication systems.

In one example aspect, a wireless communication method is disclosed. The method includes receiving, by a wireless communication device, from a network device, a radio resource control (RRC) signaling; wherein the RRC signaling includes at least a channel state information (CSI) report configuration and a CSI resource configuration; transmitting, by the wireless communication device, a complete CSI report according to the RRC signaling; wherein the complete CSI report contains multiple CSI reports.

In another example aspect, another wireless communication method is disclosed. The method includes transmitting, to a wireless communication device, from a network device, a radio resource control (RRC) signaling; wherein the RRC signaling includes at least a channel state information (CSI) report configuration and a CSI resource configuration; receiving, from the wireless communication device, a complete CSI report according to the RRC signaling; wherein the complete CSI report contains multiple CSI reports.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 illustrates an example of a predefined table.

FIG. 2 illustrates an example of a predefined table.

FIG. 3 illustrates an example of simulation results of reporting multiple CSI in one report.

FIG. 4 illustrates another example of simulation results of reporting multiple CSI in one report.

FIG. 5 is a flowchart illustrating an example method.

FIG. 6 is a flowchart illustrating an example method.

FIG. 7 is a block diagram example of a wireless communication system.

FIG. 8 is a flowchart of an example method of wireless communication.

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

Large bandwidth, multi-antenna transmitters or receivers are used in 5G communication system. The overhead of RI (rank indicator) is large when multiple channel state information (CSI) reports are reported. In this document, joint coding RI and differential (or offset) RI report are proposed.

The number of ports of a CSI-RS (reference signal) is configured by nrofPorts in CSI-ResourceMapping, CSI-ResourceMapping is associated with a NZP-CSI-RS-Resource. The nrofPorts can be one of the following: p1, p2, p4, p8, p12, p16, p24, p32. NZP-CSI-RS-Resource include power control offset (powerControlOffset) and power control offset SS (powerControlOffsetSS), powerControlOffset or powerControlOffsetSS can affect transmission. power.

powerControlOffset: which is the assumed ratio of PDSCH EPRE to NZP CSI-RS EPRE when UE derives CSI feedback and takes values in the range of [−8, 15] dB with 1 dB step size.

powerControlOffsetSS: which is the assumed ratio of NZP (Non-zero power) CSI-RS EPRE to SS/PBCH (Synchronisation signal/Physical broadcast channel) block EPRE (Energy per resource element).

If the number of base station antennas or base station transmission power changes, the channel may change. It is helpful if UE (user equipment) can provide channel measurements of different antenna port number or different base station transmission power. In prior art, most CSI-RS resource settings and CSI report configurations are configured by RRC (Radio Resource Control) signaling. Usually, one CSI-ReportConfig associates with one CSI-ResourceConfig with one number of ports or one transmission power. That is, one CSI report only includes the report about CSI-RS with one number of ports or one transmission power. If UE needs to report CSI report about CSI-RS with multiple number of ports or multiple transmission powers, UE should report multiple CSI reports and each CSI report includes a report about one number of ports or one transmission power. This method needs to report multiple RIs. In this document, in order to reduce the overhead of multiple RIs, a method that UE reports in a single reporting instance multiple CRI, RI for each number of ports or different transmission power which are associated with a report setting is provided.

From the UE side, receiving a RRC signaling that includes at least a CSI report configuration information and a CSI resource configuration information. Then performing. joint coding or differential operation of multiple RI, and then report a complete CSI report according to the RRC signaling. The complete CSI report contains multiple CSI reports. Each CSI report contains a rank indicator (RI) value, the RI value can be indicated explicitly or implicitly.

RI value that is indicated explicitly means that the RI value is specifically defined. RI value that is indicated implicitly means that the RI values should be derived from other parameters. For example, UE reports a codepoint, and the RI values should be the RI values which associate with the codepoint. As another example, UE reports an offset value, and the RI value is derived according to the offset value.

In some embodiments, RI value is indicated explicitly means the RI values or the parameters used to derive RI values is transmitted. In some embodiments, RI value is indicated implicitly means the RI values is not transmitted, and the RI value should be derived from other parameters.

In some embodiments, the multiple RI values in the complete CSI report are jointly coded.

In some embodiments, each RI in the complete CSI report is associated with a number of ports. Associated with a number of ports means associated with a resource and the resource is associated with a number of ports. For example, a RI is for a CSI resource configuration, and the CSI resource configuration includes CSI resource configured with a number of ports, then the RI is associated with the number of ports. As another example, a RI is for a CSI resource set, and the CSI resource set includes CSI resource configured with a number of ports, then the RI is associated with the number of ports.

The resource may associate with a number of ports or a power offset. In some embodiments, a resource including one or more CSI resource may include at least one of the following: a CSI resource, a CSI resource set, a CSI resource group, a CSI resource setting, and a CSI resource set group.

The largest resource may correspond to at least one of the following: resource associated with maximum number of ports, resource associated with minimum powerControlOffset, resource associate with maximum powerControlOffsetSS, resource associated with a time and frequency resource which is a union (or whole) set among all the resource which associate with a same CSI reporting.

Different resource may include at least: resource with different number of ports, resource with different power control offset, resource with different power control offset SS.

In some embodiments, a first resources which is associated with a first CSI sub-report is a subset of a second resources which is associated with a second CSI sub-reports. In some embodiments, subset means the time and frequency resource of a first resource is part (or subset) of the time and frequency resource of a second resource. In some embodiments, a first resource is a subset of a second resource means that the number of ports which associate with the first resource is less than or equal to the number of ports which associate with the second resource. In some embodiments, a first resource is a subset of a second resource means the power offset which associate with the first resource is greater than or equal to the power offset which associate with the second resource. In some embodiments, a first resource is a subset of a second resource means the that first resource is overlapped with the second resource.

In some embodiments, a first RI value associated with a first number of ports is greater than or equal to a second RI value associated with a second number of ports. The first number of ports is greater than the second number of ports. The same relationship goes on for subsequent RI values.

In some embodiments, a joint coding is applied if the number of codeword associated with each number of ports is one. In some embodiments, a joint coding is applied if the number of codeword associated with each number of ports is same.

In some embodiments, the joint coding is applied if each RI is not greater than 4.

In some embodiments, each RI in the complete CSI report is associated with different transmission power.

In some embodiments, a first RI value associated with a first transmission power is greater than or equal to a second RI value associated with a second transmission power. The first transmission power is greater than the second transmission power. The same relationship goes on for subsequent RI values.

Jointly coded means a codepoint of a RI indication indicates multiple RI values in one CSI report. In prior art, a codepoint of a RI indication indicates one RI value. In some embodiments, each RI value in the multiple RI values is associated with a number of ports.

In some embodiments, a predefined table is provided, a codepoint of RI indication is reported in the complete CSI report. Each codepoint is associated with a set of RI values associated with different resource or number of ports.

Table 1 shows an example of a predefined table.

TABLE 1

| | RI value for first | | RI value for Nth |
|---|---|---|---|
| codepoint | number of ports | . . . | number of ports |
| A | 8 | . . . | 5 |
| B | 2 | . . . | 2 |
| . . . | . . . | . . . | . . . |
| M | 3 | . . . | 3 |

Table 2 below shows another example of a predefined table. In this example, 3 RI values are reported in one complete CSI report. Different RI is associated with different number of ports. For example, RI #1 is a RI value for a CSI resource configuration which includes CSI resource configured with 32 ports, RI #2 is a RI value for a CSI resource configuration which includes CSI resource configured with 16 ports, RI #3 is a RI value for a CSI resource configuration which includes CSI resource configured with 8 ports. The maximum RI value is 4.

TABLE 2

| codepoint | RI#1 | RI#2 | RI#3 |
|---|---|---|---|
| 00000 | 4 | 4 | 4 |
| 00001 | 4 | 4 | 3 |
| 00010 | 4 | 4 | 2 |
| 00011 | 4 | 4 | 1 |
| 00100 | 4 | 3 | 3 |
| 00101 | 4 | 3 | 2 |
| 00110 | 4 | 3 | 1 |
| 00111 | 4 | 2 | 2 |
| 01000 | 4 | 2 | 1 |
| 01001 | 4 | 1 | 1 |
| 01010 | 3 | 3 | 3 |
| 01011 | 3 | 3 | 2 |
| 01100 | 3 | 3 | 1 |
| 01101 | 3 | 2 | 2 |
| 01110 | 3 | 2 | 1 |
| 01111 | 3 | 1 | 1 |
| 10000 | 2 | 2 | 2 |
| 10001 | 2 | 2 | 1 |
| 10010 | 2 | 1 | 1 |
| 10011 | 1 | 1 | 1 |

Table 3 below shows another example of a predefined table. In this example, 2 RI values are reported in one multiple CSI report.

TABLE 3

| codepoint | RI#1 | RI#2 |
|---|---|---|
| 0000 | 4 | 4 |
| 0001 | 4 | 3 |
| 0010 | 4 | 2 |
| 0011 | 4 | 1 |
| 0100 | 3 | 3 |
| 0101 | 3 | 2 |
| 0110 | 3 | 1 |
| 0111 | 2 | 2 |
| 1000 | 2 | 1 |
| 1001 | 1 | 1 |

Tables 4-7 below show other examples of a predefined tables. 4 RI values, 3 RI values and 2 RI values can be obtained in one complete CSI report.

TABLE 4

| codepoint | RI#1 | RI#2 | RI#3 |
|---|---|---|---|
| 00000 | 4 | 4 | 0 |
| 00001 | 4 | 4 | 4 |
| 00010 | 4 | 3 | 0 |
| 00011 | 4 | 4 | 3 |
| 00100 | 4 | 2 | 0 |
| 00101 | 4 | 4 | 2 |
| 00110 | 4 | 1 | 0 |
| 00111 | 4 | 4 | 1 |
| 01000 | 3 | 3 | 0 |
| 01001 | 4 | 3 | 3 |
| 01010 | 3 | 2 | 0 |
| 01011 | 4 | 3 | 2 |
| 01100 | 3 | 1 | 0 |
| 01101 | 4 | 3 | 1 |
| 01110 | 2 | 2 | 0 |
| 01111 | 4 | 2 | 2 |
| 10000 | 2 | 1 | 0 |
| 10001 | 4 | 2 | 1 |
| 10010 | 1 | 1 | 0 |
| 10011 | 4 | 1 | 1 |
| 10100 | 3 | 3 | 3 |
| 10101 | 3 | 3 | 2 |
| 10110 | 3 | 3 | 1 |
| 10111 | 3 | 2 | 2 |
| 11000 | 3 | 2 | 1 |
| 11001 | 3 | 1 | 1 |
| 11010 | 2 | 2 | 2 |
| 11011 | 2 | 2 | 1 |
| 11100 | 2 | 1 | 1 |
| 11101 | 1 | 1 | 1 |

TABLE 5

| codepoint | RI#1 | RI#2 | RI#3 |
|---|---|---|---|
| 00000 | 4 | 4 | 0 |
| 00001 | 4 | 3 | 0 |
| 00010 | 4 | 2 | 0 |
| 00011 | 4 | 1 | 0 |
| 00100 | 3 | 3 | 0 |
| 00101 | 3 | 2 | 0 |
| 00110 | 3 | 1 | 0 |
| 00111 | 2 | 2 | 0 |
| 01000 | 2 | 1 | 0 |
| 01001 | 1 | 1 | 0 |
| 01010 | 4 | 4 | 4 |
| 01011 | 4 | 4 | 3 |
| 01100 | 4 | 4 | 2 |
| 01101 | 4 | 4 | 1 |
| 01110 | 4 | 3 | 3 |
| 01111 | 4 | 3 | 2 |
| 10000 | 4 | 3 | 1 |
| 10001 | 4 | 2 | 2 |
| 10010 | 4 | 2 | 1 |
| 10011 | 4 | 1 | 1 |
| 10100 | 3 | 3 | 3 |
| 10101 | 3 | 3 | 2 |
| 10110 | 3 | 3 | 1 |
| 10111 | 3 | 2 | 2 |
| 11000 | 3 | 2 | 1 |
| 11001 | 3 | 1 | 1 |
| 11010 | 2 | 2 | 2 |
| 11011 | 2 | 2 | 1 |
| 11100 | 2 | 1 | 1 |
| 11101 | 1 | 1 | 1 |

TABLE 6

| codepoint | RI#1 | RI#2 | RI#3 |
|---|---|---|---|
| 00000 | 4 | 4 | 4 |
| 00001 | 4 | 3 | 3 |
| 00010 | 4 | 2 | 2 |
| 00011 | 4 | 1 | 1 |
| 00100 | 3 | 3 | 3 |
| 00101 | 3 | 2 | 2 |
| 00110 | 3 | 1 | 1 |
| 00111 | 2 | 2 | 2 |
| 01000 | 2 | 1 | 1 |
| 01001 | 1 | 1 | 1 |
| 01010 | 4 | 4 | 3 |
| 01011 | 4 | 4 | 2 |
| 01100 | 4 | 4 | 1 |
| 01101 | 4 | 3 | 2 |
| 01110 | 4 | 3 | 1 |
| 01111 | 4 | 2 | 1 |
| 10000 | 3 | 3 | 2 |
| 10001 | 3 | 3 | 1 |
| 10010 | 3 | 2 | 1 |
| 10011 | 2 | 2 | 1 |

TABLE 7

| codepoint | RI#1 | RI#2 | RI#3 | RI#4 |
|---|---|---|---|---|
| 000000 | 4 | 4 | 4 | 4 |
| 000001 | 4 | 3 | 3 | 3 |
| 000010 | 4 | 2 | 2 | 2 |
| 000011 | 4 | 1 | 1 | 1 |
| 000100 | 3 | 3 | 3 | 3 |
| 000101 | 3 | 2 | 2 | 2 |
| 000110 | 3 | 1 | 1 | 1 |
| 000111 | 2 | 2 | 2 | 1 |
| 001000 | 2 | 1 | 1 | 1 |
| 001001 | 1 | 1 | 1 | 1 |
| 001010 | 4 | 4 | 3 | 3 |
| 001011 | 4 | 4 | 2 | 2 |
| 001100 | 4 | 4 | 1 | 1 |
| 001101 | 4 | 3 | 2 | 2 |
| 001110 | 4 | 3 | 1 | 1 |
| 001111 | 4 | 2 | 1 | 1 |
| 010000 | 3 | 3 | 2 | 2 |
| 010001 | 3 | 3 | 1 | 1 |
| 010010 | 3 | 2 | 1 | 1 |
| 010011 | 2 | 2 | 1 | 1 |
| 001010 | 4 | 4 | 4 | 3 |
| 001011 | 4 | 4 | 4 | 2 |
| 001100 | 4 | 4 | 4 | 1 |
| 001101 | 4 | 4 | 3 | 2 |
| 001110 | 4 | 4 | 3 | 1 |
| 001111 | 4 | 4 | 2 | 1 |
| 010000 | 4 | 3 | 3 | 2 |
| 010001 | 4 | 3 | 3 | 1 |
| 010010 | 4 | 3 | 2 | 1 |
| 010011 | 4 | 2 | 2 | 1 |
| 010100 | 3 | 3 | 3 | 2 |
| 010101 | 3 | 3 | 3 | 1 |
| 010111 | 3 | 3 | 2 | 1 |

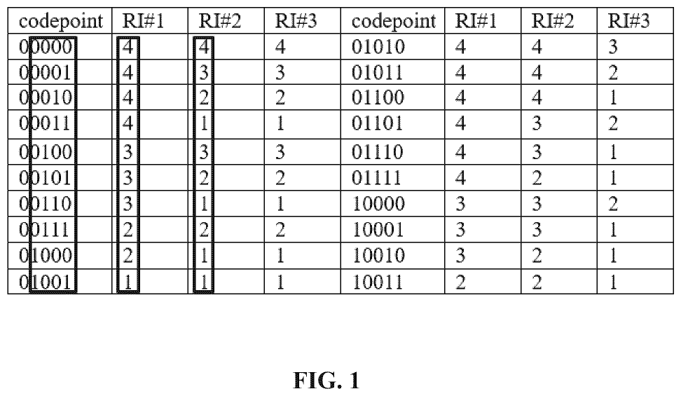

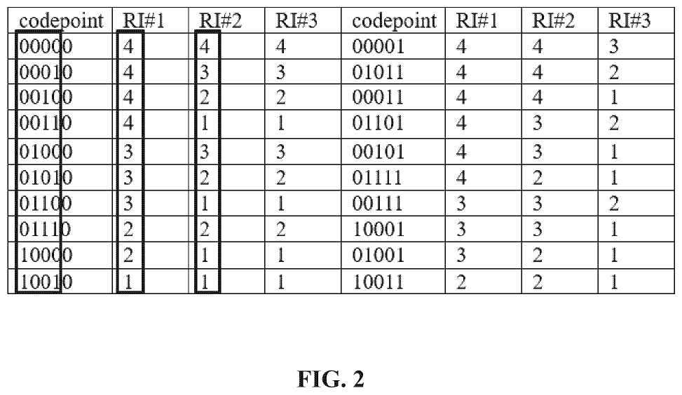

Taking the above TABLE 6 as an example, when only one table is defined to represent the relationship of 2 RIs and 3 RIs, taking the first or last 4 bits of the 10 codepoint can also yield results as shown in TABLE 3, as illustrated in TABLES 6-1 and 6-2, also shown as FIGS. 1-2.

TABLE 6-1

| codepoint | RI#1 | RI#2 RI#3 |
|---|---|---|
| 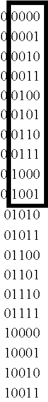 | 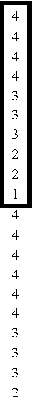 | 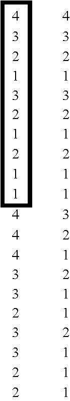 |

TABLE 6-2

| codepoint | RI#1 | RI#2 RI#3 |
|---|---|---|
| 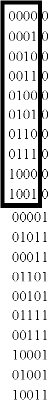 | 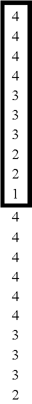 | 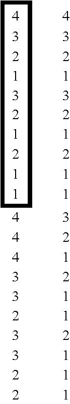 |

In some embodiments, a first RI value associated with a first number of ports is greater than or equal to a second RI value associated with a second number of ports. The first number of ports is greater than the second number of ports.

In some embodiments, more than one predefined tables are provided, different predefined values are used for different number of RI values reported in one complete CSI report. For example, if two RI values need to be reported in one complete CSI report, TABLE 3 is used; if three RI values need to be reported in one complete CSI report, TABLE 2 is used.

In some embodiments, one predefined table is provided for different number of RI values reported in one complete CSI report. For example, if two RI values or three RI values need to be reported in one complete CSI report, TABLE 4, TABLE 5 or TABLE 6 can be used. To emphasize, only the first four bits or the last four bits of codepoint to indicate RI values when two RI values is needed to report in one complete CSI report.

In some embodiments, joint coding is used if more than two RI values are reported in one complete CSI report. In some embodiments, joint coding is used for reporting RI values in one complete CSI report, if the complete CSI report is linked to or associated with different resource port number. Different resource port number correspond to CSI resource configuration, CSI-RS resource set, CSI-RS resource, CSI-RS resource set group, or CSI-RS resource group configured with different number of ports.

In some embodiments, the RI values for different resource port number reported in one complete CSI report is reported or encoded separately according to a predefined order.

In some embodiments, the predefined order may be at least one of the following: an order of resource group ID which associate with a CSI report, an order of associated number of ports (e.g., from large to small), and the order of associated power offset (e.g., from large to small).

The order of associated number of ports can be, for example, RI values for 32,16,8,4 ports are to be reported in one CSI report. The RI value for 32 ports is reported directly. The differential RI values for other number of ports are reported according to the order of the differential RI value associated with 16 ports, differential RI value associated with 8 ports, differential RI value associated with 4 ports. The order of number of ports/power offset configured in the CSI report configuration means the order index of ordering for each number of ports or power offset first in CSI resource (e.g., NZP-CSI-RS-Resource) order, and then in CSI resource set (NZP-CSI-RS-ResourceSet) order, and then in CSI resource setting (CSI-ResourceConfig) order linked to a CSI report configuration.

In some embodiments, the RI value for the resource which is associated with maximum number of ports is reported directly. The RI values for the resource associated with the other number of ports are reported via differential (or offset) RI values. The differential (or offset) RI value indicates difference between a reference RI value and the RI value.

In some embodiments, the RI value for the resource which is associated with the minimum powerControlOffset is reported directly. The RI values for the resource associated with the others powerControlOffset are reported via differential (or offset) RI values. The differential (or offset) RI value indicates difference between a reference RI value and the RI value.

In some embodiments, the RI value for the resource which is associated with the maximum powerControlOffsetSS is reported directly. The RI values for the resource associated with the others values powerControlOffsetSS are reported via differential (or offset) RI values. The differential (or offset) RI value indicates difference between a reference RI value and the RI value.

The resource that uses for the maximum RI value is indicated by one of the following: indicate the resource ID (e.g., CSI-ResourceConfigID or CSI resource set ID, or CSI resource ID), indicate the resource group ID (e.g., CSI resource set group ID, CSI resource group ID), indicate the number of ports, and indicate power offset (powerControlOffset, powerControlOffsetSS), indicate CRI.

In some embodiments, the differential (or offset) RI values for the other resource are reported in order. The order is one of the following: the order of resource ID, the order of resource group ID, and the order of number of ports (e.g., from large to small).

In some embodiments, the reference RI value is one of the following: RI value for the resource which is associated with maximum number of ports in the same complete CSI report; maximum RI value in the same complete CSI report; and a prior RI value. For example, the prior RI value of the N^{th} RI value is the N−1th RI value. In some embodiments, the order of RI value is same as the order of number of ports associated with the CSI report configuration. For example, a CSI report configuration associated with three CSI resource configuration. The number of ports of the three CSI resource configuration is 32 ports, 24 ports, 16 ports, respectively. Then the 1st RI value is the RI value for CSI resource configuration configured with 32 ports, the 2nd RI value is the RI value for CSI resource configuration configured with 24 ports, the 3rd RI value is the RI value for CSI resource configuration configured with 16 ports.

In some embodiments, the differential (or offset) RI value indicates a value X which means the RI value is X smaller than the reference RI value. X is an integer greater than or equal to 0 and less than 7. In some embodiments, X can be 0, 1. In some embodiments, X can be 0, 1, 2, 3. In some embodiments, X can be 0, 1, 2, 4. In another word, the RI value derived from the differential RI value and the reference RI value is equal to reference RI value-X.

In some embodiments, the differential (or offset) RI value is indicated by 1 bit. ‘0’ means X=0, ‘1’ means X=1.

In some embodiments, the differential (or offset) RI value is indicated by Y bits. Each codepoint of the Y bits corresponding to a value of X. the relationship of the codepoint and X is predefined.

In some embodiments, the differential (or offset) RI value indicate a number of steps (e.g., U) corresponding to a reference RI value. The step size is 1 or 2. The RI value derived by the differential RI value is equal to reference RI value-U*step size. U is an integer greater than or equal to 0 and less than 4.

Table 8 shows an example of differential (or offset) RI. In this example, 4 RI values need to be reported, RI value for maximum number of ports is reported. The RI values for the other number of ports are reported using differential RI value.

TABLE 8

| | RI#1 | RI#2 | RI#3 | RI#4 |
|---|---|---|---|---|
| content | RI value | Differential | Differential | Differential |
| | for maximum | RI value for | RI value for | RI value for |
| | number of | second number | third number | forth number |
| | ports | of ports | of ports | of ports |
| Example 1 | 4 | 0 | 1 | 1 |
| Example 2 | 6 | 0 | 0 | 1 |
| (step | | | | |
| size = 2) | | | | |
| Example 3 | 4 | 0 | 1 | 0 |

In example 1, reference RI value is the RI value for maximum number of ports. Differential RI value indicates a X, the RI value is equal to reference RI value-X. Hence, RI #2=4, RI #3=RI #4=3.

In example 2, reference RI value is the RI value for maximum number of ports. Differential RI value indicates a U, the RI value is equal to reference RI value-U*step size. Hence, RI #2=RI #3=6, RI #4=4.

In example 3, reference RI value is the prior RI value. Differential RI value indicates a X, the RI value is equal to reference RI value-X. Hence, RI #2=4, RI #3=RI #4=3.

In some embodiments, only one RI value needs to be reported. The RI values is the RI value of maximum number of ports. Others RI value associated with a number of ports is the same as the RI value.

In some embodiments, one RI value needs to be reported. The RI values is the RI value of maximum transmission power. Others RI value associated with a transmission power is the same as the RI value.

In some embodiments, part of RI values are reported, the other RI values can be obtained by linear interpolation and/or RI values which are reported. Tables 8-11 indicates the function f of linear interpolation.

In some embodiments, RI values in odd positions or even positions are reported, the other RI values are not reported. RI values in odd positions can be obtained by interpolating RI values in even positions or RI values in even positions can be obtained by linear interpolating RI values in odd positions. For example, the value of RI #2 can be obtained by linear interpolating RI #1 and RI #3 and taking integers, the value of RI #4 can be obtained in the same way, noting that the minimum of RI value is 1, shown in TABLE 9. Another example, the value of RI #3 can be obtained by linear interpolating RI #2 and RI #4 and taking integers, the value of RI #1 can be obtained in the same way, noting that the maximum of RI value is 4, shown in TABLE 10.

In some embodiments, RI values can be obtained by previous RI value and linear interpolating operation. For example, the value of RI #2 can be obtained through RI #1-step, step is equal to RI1 minus RI4 and divided by 2, after that, the value of RI #3 can be obtained by linear interpolating RI #2 and RI #4 and taking integers, shown in TABLE 11. Another example, the value of RI #3 can be obtained through RI #4+ step, step is equal to RI1 minus RI4 and divided by 2, after that, the value of RI #2 can be obtained by linear interpolating RI #1 and RI #3 and taking integers, shown in TABLE 12. Noting that the maximum and the minimum of RI value is 4 and 1.

Linear interpolating means using a straight line connecting two known values to determine an unknown value between these two known values.

Take integers means take whole numbers or to the nearest whole numbers.

TABLE 9

| | RI#1 | RI#2 | RI#3 | RI#4 |
|---|---|---|---|---|
| content | RI value for | RI value for | RI value for | RI value for |
| | maximum | second number | third number | forth number |
| | number of | of ports | of ports | of ports |
| | ports | | | |
| Example 1 | 4 | ceil(f(RI#1, | 2 | max(1, |
| | | RI#3)) or | | floor(f(RI#2, |
| | | floor(f(RI#1, | | RI#4)))) or |
| | | RI#3))) | | max(1, |
| | | | | ceil(f(RI#2, |
| | | | | RI#4)))) |

TABLE 10

| | RI#1 | RI#2 | RI#3 | RI#4 |
|---|---|---|---|---|
| content | RI value for | RI value for | RI value for | RI value for |
| | maximum | second number | third number | forth number |
| | number of | of ports | of ports | of ports |
| | ports | | | |
| Example 1 | min(4, | 3 | ceil(f(RI#2, | 2 |
| | floor(f(RI#2, | | RI#4)) or | |
| | RI#4)))) or | | floor(f(RI#2, | |
| | min(4, | | RI#4))) | |
| | ceil(f(RI#2, | | | |
| | RI#4)))) | | | |

TABLE 11

| | RI#1 | RI#2 | RI#3 | RI#4 |
|---|---|---|---|---|
| content | RI value for | RI value for | RI value for | RI value for |
| | maximum | second number | third number | fourth number |
| | number of | of ports | of ports | of ports |
| | ports | | | |
| Example 1 | 4 | RI#1 − step, | ceil(f(RI#2, | 2 |
| | | step = floor | RI#4)) or | |
| | | (RI#1 − | floor(f(RI#2, | |
| | | RI#4)/2) | RI#4))) | |

TABLE 12

| | RI#1 | RI#2 | RI#3 | RI#4 |
|---|---|---|---|---|
| content | RI value for | RI value for | RI value for | RI value for |
| | maximum | second number | third number | fourth number |
| | number of | of ports | of ports | of ports |
| | ports | | | |
| Example 1 | 4 | ceil(f(RI#1, | RI#4 + step, | 2 |
| | | RI#3)) or | step = floor | |
| | | floor(f(RI#1, | (RI#1 − | |
| | | RI#3))) | RI#4)/2) | |

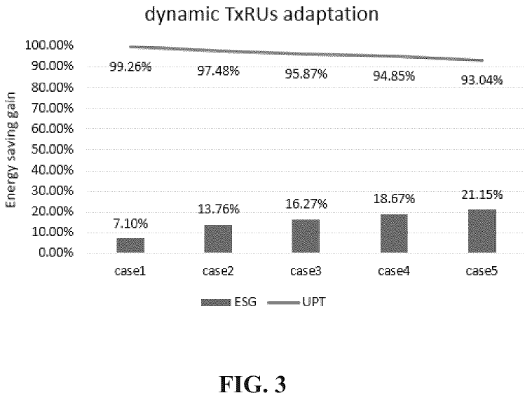

FIG. 3 illustrates simulation results of reporting multiple CSI in one report. UE performs measurements and generates multiple CSI according to CSI resource associate with different number of ports and reports the multiple CSI in one reporting. gNB can dynamically adapt the number of TxRUs among {64TxRUs, 32TxRUs, 16TxRUs, 8TxRUs, 4TxRUs}, based on the CSI reporting. When gNB turns off some TxRUs, the power consumption can be reduced.

According to the simulation results, dynamic adapt TxRUs according to the multiple CSI in one report has at most 21.15% energy saving gain compared with Baseline scheme. The Baseline scheme is gNB always turns on 64TxRUs.

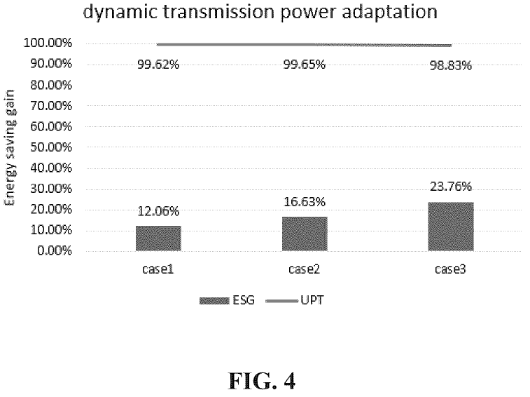

FIG. 4 illustrates another simulation results of reporting multiple CSI in one report. UE performs measurements and generates multiple CSI according to CSI resource associate with different power offsets configuration and reports the multiple CSI in one reporting. gNB can dynamically adapt the transmission power of PDSCH among {55 dBm, 52 dBm, 49 dBm, 46 dBm, 43 dBm}, based on the CSI reporting. When gNB reduces the transmission power, the power consumption can be reduced.

According to the simulation results, dynamic adapt transmission power according to the multiple CSI in one report has at most 23.76% energy saving gain compared with Baseline scheme. The Baseline scheme is the transmission power is always 55 dBm.

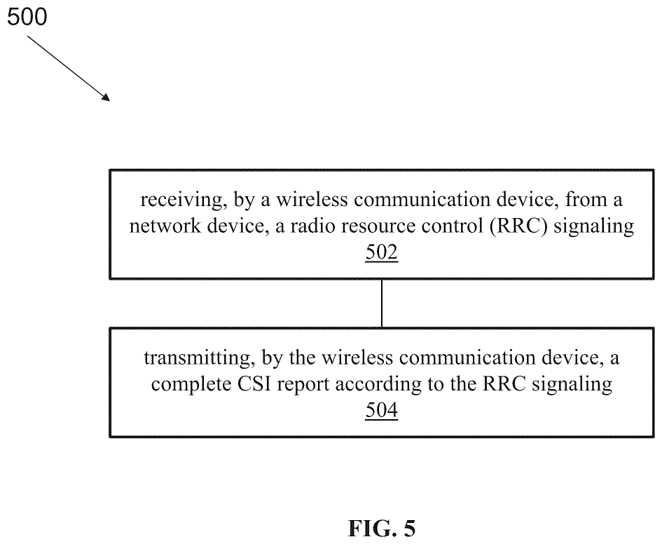

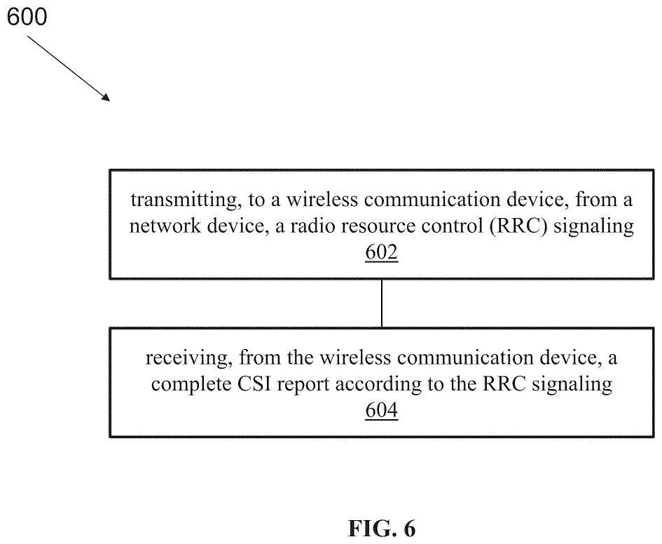

Accordingly, some preferred embodiments may use the following solutions.
1. A method of wireless communication, as disclosed in FIG. 5: including receiving, by a wireless communication device, from a network device, a radio resource control (RRC) signaling (502); wherein the RRC signaling includes at least a channel state information (CSI) report configuration and a CSI resource configuration; transmitting, by the wireless communication device, a complete CSI report according to the RRC signaling (504); wherein the complete CSI report contains multiple CSI reports. Additional details and examples are discussed in the detailed description and with reference to FIGS. 1 to 4.
2. The method of solution 1, wherein each CSI report contains a rank indicator (RI) value, the RI value can be indicated explicitly or implicitly.
3. The method of solution 2, wherein the RI value in each CSI report is associated with a resource for the CSI report.
4. The method of solution 3, wherein the resource for the CSI report is at least one of the following: a CSI resource, a CSI resource set, a CSI resource group, a CSI resource setting, and a CSI resource set group.
5. The method of solution 4, wherein the resource include at least one of the following: a number of ports and a transmission power offset.
6. The method of solution 5, wherein a first RI value is associated with a first resource for the CSI report; wherein a second RI value is associated with a second resource for the CSI report; wherein the second RI value is less than or equal to the first RI value; wherein the second resource is a subset of the first resource.
7. The method of solution 6, wherein RI values in the complete CSI report are implicitly indicated based on joint coding; wherein the joint coding further comprising: determining a codepoint associated with the RI values in the complete CSI report.
8. The method of solution 7, wherein the RI values in the complete CSI report satisfy the following condition: the second RI value is less than or equal to the first RI value, wherein the second resource that is associated with the second RI value is a subset of the first resource that is associated with the first RI value.
9. The method of solution 8, wherein the codepoints associated the RI values are identified in a predefined table.
10. The method of solution 9, wherein different predefined tables are used for different number of RI values reported in the complete CSI report.
11. The method of solution 9, wherein a sub-predefined table for a first number of RI values associated with a codepoint in the complete CSI report is derived from the predefined table; wherein the codepoint in the sub-predefined table is part of the codepoint in the predefined table; wherein the first number of RI values in the sub-predefined table is less than the number of RI values associated with a codepoint in the predefined table; wherein the sub-predefined table identifies a number of RI values in the complete CSI report.
12. The method of solution 3, wherein the RI values in the complete CSI report are reported or encoded according to a predefined order; wherein the predefined order includes at least one of the following: the order of a resource group ID associated with a CSI report, the order of the number of ports, and the order of the transmission power offset.
13. The method of solution 2, wherein the complete CSI report further contains multiple types of CSI report; wherein an explicit RI value is associated with a first type CSI report; wherein an implicit RI value is associated with a second type CSI report; wherein the implicit RI value is an offset value; wherein the offset value is a difference between a reference RI value and the RI value that is associated with the second type CSI report.
14. The method of solution 13, wherein the first type CSI report is associated with the largest resource and the second type CSI report does not associate with the largest resource.
15. The method of solution 13, wherein the reference RI value of a N^{th} CSI report is the RI value of a (N-1)^{th} CSI report.
16. The method of solution 13, wherein the reference RI value is the explicit RI value that is associated with a first type CSI report, the first type CSI report contains at least one of the following: a CSI report that associates with a maximum RI value, and a predefined CSI report.
17. The method of solution 2, wherein a RI value of a CSI report associate with the largest resource is explicit indicated and the other RI values are implicit indicated according to the RI value of a CSI report associate with the largest resource; wherein the other RI values are equal to the RI value of a CSI report associate with the largest resource.
18. The method of solution 2, the complete CSI report further contains a third type CSI report; wherein an explicit RI value is associated with the third type CSI report; wherein an implicit RI value is associated with other types of CSI report; wherein the implicit RI values are obtained by the RI values of the third type CSI report or by a linear interpolating operation.
19. The method of solution 18, wherein the third type CSI report is at least one of the following: a CSI report associate with an odd index, a CSI report associate with an even index, a predefined CSI report, and a CSI report associate with a predefined resource.
20. A method of wireless communication, as disclosed in FIG. 6: including transmitting, to a wireless communication device, from a network device, a radio resource control (RRC) signaling (602); wherein the RRC signaling includes at least a channel state information (CSI) report configuration and a CSI resource configuration; receiving, from the wireless communication device, a complete CSI report according to the RRC signaling (604); wherein the complete CSI report contains multiple CSI reports. Additional details and examples are discussed in the detailed description and with reference to FIGS. 1 to 4.
21. The method of solution 20, wherein each CSI report contains a rank indicator (RI) value, the RI value can be indicated explicitly or implicitly.
22. The method of solution 21, wherein the RI value in each CSI report is associated with a resource for the CSI report.
23. The method of solution 22, wherein the resource for the CSI report is at least one of the following: a CSI resource, a CSI resource set, a CSI resource group, a CSI resource setting, and a CSI resource set group.
24. The method of solution 23, wherein the resource include at least one of the following: a number of ports and a transmission power offset.
25. The method of solution 24, wherein a first RI value is associated with a first resource for the CSI report; wherein a second RI value is associated with a second resource for the CSI report; wherein the second RI value is less than or equal to the first RI value; wherein the second resource is a subset of the first resource.
26. The method of solution 25, wherein RI values in the complete CSI report are implicitly indicated based on joint coding; wherein the joint coding further comprising: determining a codepoint associated with the RI values in the complete CSI report.
27. The method of solution 26, wherein the RI values in the complete CSI report satisfy the following condition: the second RI value is less than or equal to the first RI value, wherein the second resource that is associated with the second RI value is a subset of the first resource that is associated with the first RI value.
28. The method of solution 27, wherein the codepoints associated the RI values are identified in a predefined table.
29. The method of solution 28, wherein different predefined tables are used for different number of RI values reported in the complete CSI report.
30. The method of solution 28, wherein a sub-predefined table for a first number of RI values associated with a codepoint in the complete CSI report is derived from the predefined table; wherein the codepoint in the sub-predefined table is part of the codepoint in the predefined table; wherein the first number of RI values in the sub-predefined table is less than the number of RI values associated with a codepoint in the predefined table; wherein the sub-predefined table identifies a number of RI values in the complete CSI report.
31. The method of solution 22, wherein the RI values in the complete CSI report are reported or encoded according to a predefined order; wherein the predefined order includes at least one of the following: the order of a resource group ID associated with a CSI report, the order of the number of ports, and the order of the transmission power offset.
32. The method of solution 21, wherein the complete CSI report further contains multiple types of CSI report; wherein an explicit RI value is associated with a first type CSI report; wherein an implicit RI value is associated with a second type CSI report; wherein the implicit RI value is an offset value; wherein the offset value is a difference between a reference RI value and the RI value that is associated with the second type CSI report.
33. The method of solution 32, wherein the first type CSI report is associated with the largest resource and the second type CSI report does not associate with the largest resource.
34. The method of solution 32, wherein the reference RI value of a N^{th} CSI report is the RI value of a (N-1)^{th} CSI report.
35. The method of solution 32, wherein the reference RI value is the explicit RI value that is associated with a first type CSI report, the first type CSI report contains at least one of the following: a CSI report that associates with a maximum RI value, and a predefined CSI report.
36. The method of solution 21, wherein a RI value of a CSI report associate with the largest resource is explicit indicated and the other RI values are implicit indicated according to the RI value of a CSI report associate with the largest resource; wherein the other RI values are equal to the RI value of a CSI report associate with the largest resource.
37. The method of solution 21, the complete CSI report further contains a third type CSI report; wherein an explicit RI value is associated with the third type CSI report; wherein an implicit RI value is associated with other types of CSI report; wherein the implicit RI values are obtained by the RI values of the third type CSI report or by a linear interpolating operation.
38. The method of solution 18, wherein the third type CSI report is at least one of the following: a CSI report associate with an odd index, a CSI report associate with an even index, a predefined CSI report, and a CSI report associate with a predefined resource.
39. A communication apparatus comprising a processor configured to implement a method recited in any one or more of solutions 1 to 38.
40. A computer readable medium having code stored thereon, the code, when executed, causing a processor to implement a method recited in any one or more of solutions 1 to 38.

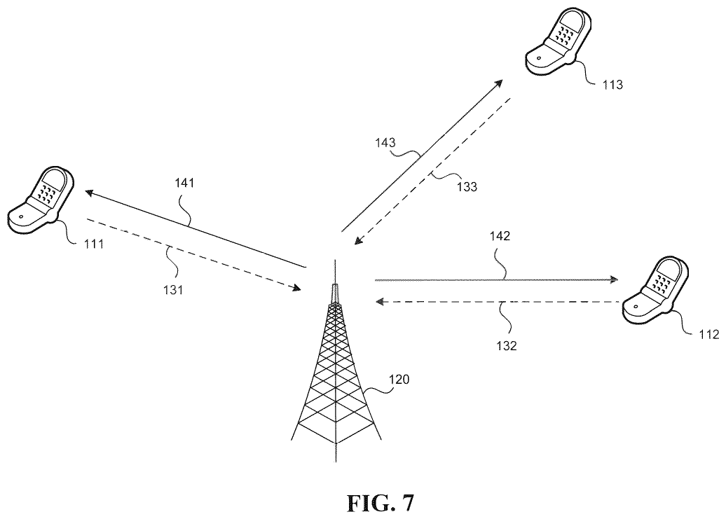

FIG. 7 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

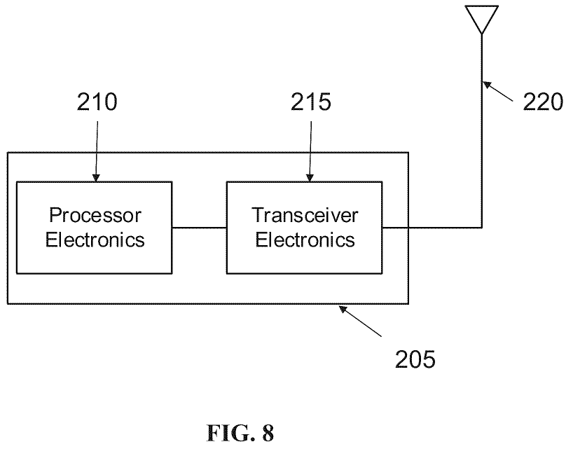

FIG. 8 is a block diagram representation of a portion of an apparatus, in accordance with some embodiments of the presently disclosed technology. An apparatus 205 such as a network device or a base station or a wireless device (or UE), can include processor electronics 210 such as a microprocessor that implements one or more of the techniques presented in this document. The apparatus 205 can include transceiver electronics 215 to send and/or receive wireless signals over one or more communication interfaces such as antenna(s) 220. The apparatus 205 can include other communication interfaces for transmitting and receiving data. Apparatus 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the apparatus 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this document.

What is claimed is:

1. A method of wireless communication, comprising:
receiving, by a wireless communication device, from a network device, a radio resource control (RRC) signaling,
wherein the RRC signaling includes at least a channel state information (CSI) report configuration and a CSI resource configuration; and
transmitting, by the wireless communication device, a complete CSI report according to the RRC signaling,
wherein the complete CSI report contains multiple CSI reports,
wherein each CSI report in the complete CSI report contains a rank indicator (RI) value of a plurality of RI values in the complete CSI report,
wherein the RI value in the each CSI report is indicated explicitly or implicitly, and
wherein the RI value in the each CSI report is associated with a resource for the each CSI report.

2. The method of claim 1, wherein the resource for the each CSI report is at least one of: a CSI resource, a CSI resource set, a CSI resource group, a CSI resource setting, or a CSI resource set group; and
wherein the resource includes at least one of: a number of ports or a transmission power offset.

3. The method of claim 2, wherein a first RI value of the plurality of RI values in the complete CSI report is associated with a first resource for a first CSI report in the complete CSI report,
wherein a second RI value of the plurality of RI values in the complete CSI report is associated with a second resource for a second CSI report in the complete CSI report,
wherein the second RI value is less than or equal to the first RI value, and
wherein the second resource is a subset of the first resource.

4. The method of claim 3, wherein the first and the second RI values in the complete CSI report are implicitly indicated based on joint coding, and
wherein the joint coding comprises:
determining a codepoint associated with the first and the second RI values.

5. The method of claim 4, wherein the codepoint associated with the first and the second RI values is identified in a predefined table of one or more predefined tables.

6. The method of claim 5, wherein different predefined tables of the one or more predefined tables are used for different numbers of RI values reported in the complete CSI report.

7. The method of claim 5, wherein a sub-predefined table for a first number of RI values associated with a first codepoint in the complete CSI report is derived from a predefined table of the one or more predefined tables for a second number of RI values associated with a second codepoint,
wherein the first codepoint is identified in the sub-predefined table and the second codepoint is identified in the predefined table,
wherein the first codepoint in the sub-predefined table is part of the second codepoint in the predefined table,
wherein the first number of RI values in the sub-predefined table is less than the second number of RI values in the predefined table, and
wherein the sub-predefined table identifies the first number of RI values in the complete CSI report.

8. The method of claim 1, wherein the plurality of RI values in the complete CSI report are reported or encoded according to a predefined order, and
wherein the predefined order includes at least one of: an order of a resource group ID associated with a CSI report, an order of number of ports, or an order of transmission power offset.

9. The method of claim 1, wherein the complete CSI report further contains multiple types of CSI reports,
wherein an explicit RI value is associated with a first type CSI report in the complete CSI report,
wherein an implicit RI value is associated with a second type CSI report in the complete CSI report,
wherein the implicit RI value associated with the second type CSI report is an offset value, and
wherein the offset value is a difference between a reference RI value and the RI value that is associated with the second type CSI report.

10. The method of claim 9, wherein the first type CSI report is associated with a largest resource and the second type CSI report is not associated with the largest resource.

11. The method of claim 9, wherein the reference RI value of an N^{th} CSI report in the complete CSI report is the RI value of an (N-1)^{th} CSI report in the complete CSI report; or
wherein the reference RI value is the explicit RI value associated with the first type CSI report, and the first type CSI report contains at least one of: a CSI report associated with a maximum RI value, or a predefined CSI report.

12. The method of claim 9, wherein the complete CSI report further contains a third type CSI report;
wherein explicit RI values are associated with the third type CSI report,
wherein implicit RI values are associated with other types of CSI reports,
wherein the implicit RI values of the other types of CSI reports are obtained by the explicit RI values of the third type CSI report or by a linear interpolating operation, and
wherein the third type CSI report is at least one of: a CSI report associated with an odd index, a CSI report associated with an even index, a predefined CSI report, or a CSI report associated with a predefined resource.

13. The method of claim 1, wherein the RI value of a CSI report, in the complete CSI report, associated with a largest resource is explicitly indicated and other RI values in the complete CSI report are implicitly indicated according to the RI value of the CSI report associated with the largest resource, and
wherein the other RI values are equal to the RI value of the CSI report associated with the largest resource.

14. A method of wireless communication, comprising:
transmitting, to a wireless communication device, from a network device, a radio resource control (RRC) signaling,
wherein the RRC signaling includes at least a channel state information (CSI) report configuration and a CSI resource configuration; and
receiving, from the wireless communication device, a complete CSI report according to the RRC signaling,
wherein the complete CSI report contains multiple CSI reports,
wherein each CSI report in the complete CSI report contains a rank indicator (RI) value of a plurality of RI values in the complete CSI report,
wherein the RI value in the each CSI report is indicated explicitly or implicitly, and
wherein the RI value in the each CSI report is associated with a resource for the each CSI report.

15. A wireless communication device, comprising at least one processor configured to:
receive, from a network device, a radio resource control (RRC) signaling,
wherein the RRC signaling includes at least a channel state information (CSI) report configuration and a CSI resource configuration; and
transmit a complete CSI report according to the RRC signaling,
wherein the complete CSI report contains multiple CSI reports,
wherein each CSI report in the complete CSI report contains a rank indicator (RI) value of a plurality of RI values in the complete CSI report,
wherein the RI value in the each CSI report is indicated explicitly or implicitly, and
wherein the RI value in the each CSI report is associated with a resource for the each CSI report.

16. The device of claim 15, wherein the resource for the each CSI report is at least one of: a CSI resource, a CSI resource set, a CSI resource group, a CSI resource setting, or a CSI resource set group; and
wherein the resource includes at least one of: a number of ports or a transmission power offset.

17. The device of claim 16, wherein a first RI value of the plurality of RI values in the complete CSI report is associated with a first resource for a first CSI report in the complete CSI report,
wherein a second RI value of the plurality of RI values in the complete CSI report is associated with a second resource for a second CSI report in the complete CSI report,
wherein the second RI value is less than or equal to the first RI value, and
wherein the second resource is a subset of the first resource.

18. The device of claim 17, wherein the first and the second RI values in the complete CSI report are implicitly indicated based on joint coding, and
wherein the at least one processor is configured, as part of the joint coding, to:
determine a codepoint associated with the first and the second RI values.

19. The device of claim 18, wherein the codepoint associated with the first and the second RI values is identified in a predefined table of one or more predefined tables.

20. The device of claim 19, wherein different predefined tables of the one or more predefined tables are used for different numbers of RI values reported in the complete CSI report.
